(19) United States
(12) Patent Application Publication
(10) Pub. No.: US 2006/0059740 A1
(43) Pub. Date: Mar. 23, 2006

(54) Merchandising tray

(76) Inventor: Frank Joseph Prineppi, Fort Lauderdale, FL (US)

Correspondence Address: BAKER & DANIELS LLP, 300 NORTH MERIDIAN STREET, SUITE 2700, INDIANAPOLIS, IN, 46204, US

(21) Appl. No.: 11/099,376

(22) Filed: Apr. 5, 2005

(30) Foreign Application Priority Data
May 15, 2004 (GB) GB0410896.5
Jun. 4, 2004 (GB) GB0412453.3
Jul. 17, 2004 (GB) GB0416084.2

(51) Int. Cl. G09F 7/00

(52) U.S. Cl. 40/492

(57) ABSTRACT

A product merchandising tray (1) including movable signage (4), movable between a stored position in which the signage is substantially hidden by at least a part of the product (2) carried by the tray and an exposed position in which the sign is readily visible to customers viewing the display.

### BACKGROUND OF THE INVENTION

1. Field of the Invention

This invention relates to merchandising trays which are used to store and display products on e.g. supermarket shelves.

2. Description of the Related Art

A problem with conventional merchandising trays, such as those made from vacuum moulded plastics, or cardboard trays, is that because they are usually loaded with products initially at their factory source, when they are placed on view for sale on e.g. a supermarket shelf, they have to be separately promoted by means of e.g. flags or other signage seeking to attract the attention of customers to the display, which can not only be tedious but can also mean that the wrong signage is used for any particular tray, particularly where there is a relatively high turnover of the product concerned and multiple trays are used.

The present invention is derived from the realisation that it would be preferable for each tray to have its own signage facility which may be optionally used to promote the product concerned.

### SUMMARY OF THE INVENTION

According to the invention there is provided a product merchandising tray comprising or including movable signage, movable between a stored position in which the signage is substantially hidden by part or all of the product carried by the tray and an exposed position in which the sign is readily visible to customers viewing the display.

Conveniently, the signage may take the form of a movable flag and associated flagstaff which may be swivellably connected to part of the merchandising tray such that it may be swivelled from a stored position in which the flag and associated staff are substantially hidden from view, to an exposed position promoting sale of the products carried by the tray. Alternatively, the signage may take the form of a flag and associated flagstaff which is slidable from alongside the merchandising tray to a position remote therefrom, e.g. overhanging a supermarket shelf when in use.

Conveniently, the flagstaff may include a living hinge near to its free end permitting part of it to be folded back upon itself and, via the use of securing means, thereby enabling temporary or permanent securing of a flag or sign thereto. Conveniently, the securing means may take the form of interlocking formations, such as raised pips co-operable with hollow sockets, which may be preformed during manufacture.

In a further embodiment of the invention, instead of the flag or sign being retained on the end of the flagstaff through the use of a living hinge and associated securing means, the free end of the flagstaff may be flattened and include a strip of double sided adhesive tape and associated cover, which may be removed to thereafter allow placement of a flag or sign as desired.

Conveniently, a socket may be provided for selectively receiving a visual enhancement device for the flag or sign, such as a battery operated LED which may flash to attract attention to the flag or sign. Alternatively, the socket for the visual enhancement device may form part of the merchandising tray itself which may therefore selectively, in use, also carry such a visual enhancement device in order to attract attention.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of a conventional prior art supermarket shelf offering new products carried on a conventional merchandising tray;

FIG. 2 is a perspective view of a merchandising tray according to the invention resting on a supermarket shelf and with swivellable signage promoting sale of the new products;

FIG. 3 is a side view of the merchandising tray of FIG. 2 with its signage in its stored position;

FIG. 4 is a side view of the merchandising tray of FIG. 2 with its signage in its display condition;

FIG. 5 is an exploded perspective view of part of the merchandising tray of FIG. 2 showing how the signage is connected thereto;

FIG. 6 is an alternative flagstaff to that shown with reference to FIGS. 2 to 5 for supporting signage;

FIG. 7 is an alternative embodiment of merchandising tray in which the signage is slidable between a stored position and an exposed display position;

FIG. 8 is a perspective view of a flagstaff incorporating a living hinge and associated locking means;

FIG. 9 shows the flagstaff of FIG. 8 with a flag or sign locked in place thereon;

FIG. 10 is an exploded view of an alternative arrangement in which a flag or sign is mountable on the flagstaff by means of double sided adhesive tape;

FIG. 11 is a perspective view of a further alternative embodiment showing visual enhancement means in the form of a battery operated LED flasher;

FIG. 12 is a perspective view of a pair of merchandising trays in accordance with another embodiment of the invention with attendant signage in respectively raised and lowered positions;

FIG. 13 is a side view of the merchandising trays of FIG. 12;

FIG. 14 is an exploded partial view of one of the merchandising trays of FIG. 12 showing a flagstaff mounting bracket partly in outline, and

FIG. 15 is a perspective view of the flagstaff mounting bracket of FIG. 14.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

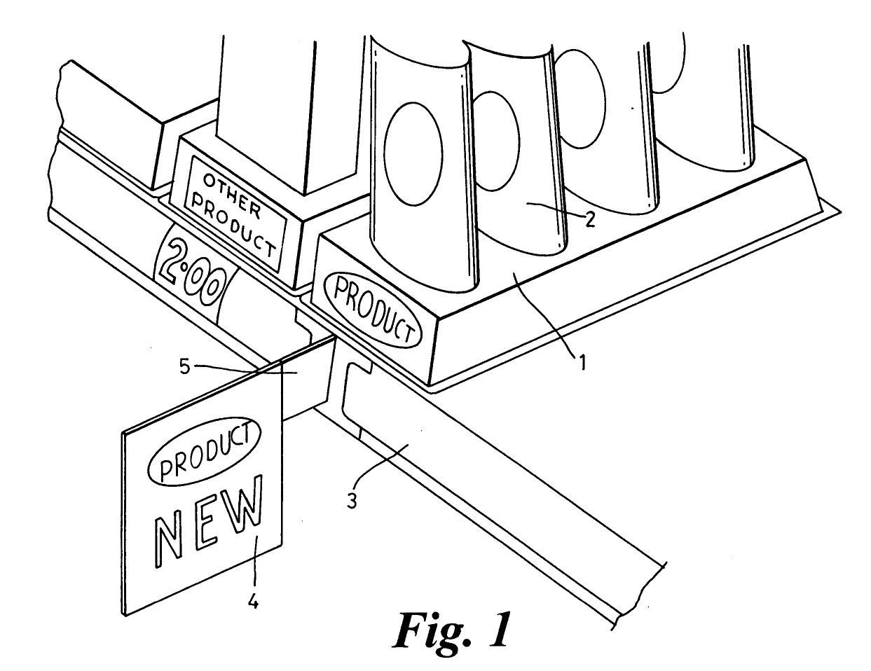

Turning firstly to FIG. 1 there is shown a conventional prior art product merchandising tray 1 carrying items of new products 2, such as bottles of shampoo, resting on a shelf 3 of e.g. a supermarket. In order to promote sale of the products 2 signage is provided by means of a sign or flag 4 secured to a movably mounted bracket 5 secured to the shelf 3.

As will be apparent, the signage 4 extends out of the eye line of the shelf 3 and merchandising tray 1 to promote the sale of the products 2, which may or may not be easily visible to potential customers. As will also be appreciated, where such merchandising trays are used by store chains it becomes necessary for promotional programmes involving sale of the products 2 to be closely co-ordinated in order to ensure that the signage 4 is consistent throughout the whole of the store chain and correctly identifies the products 2 for sale at the designated price.

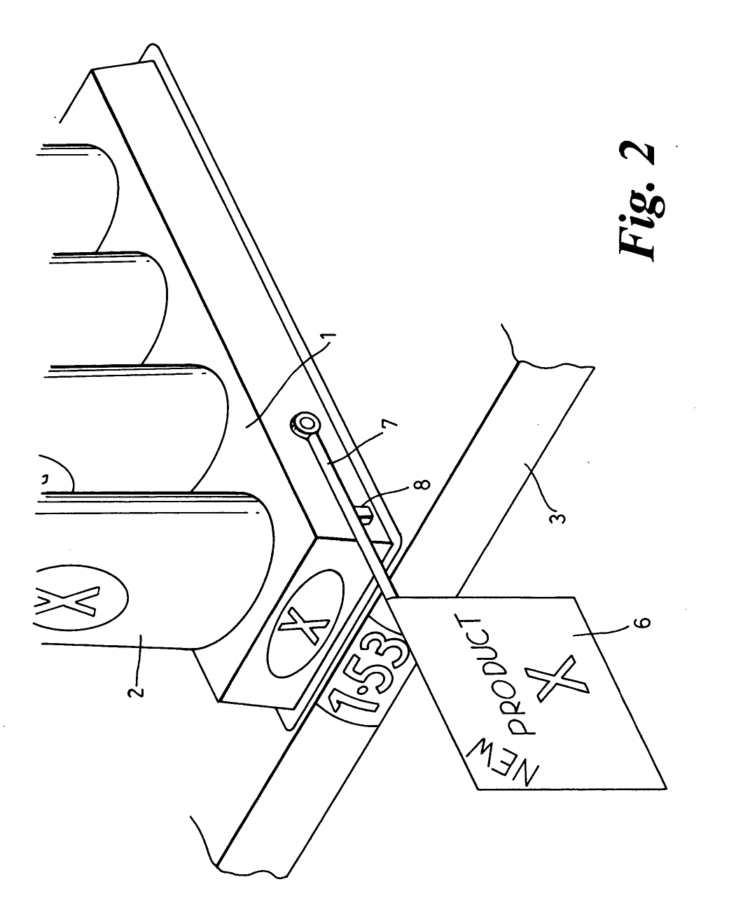

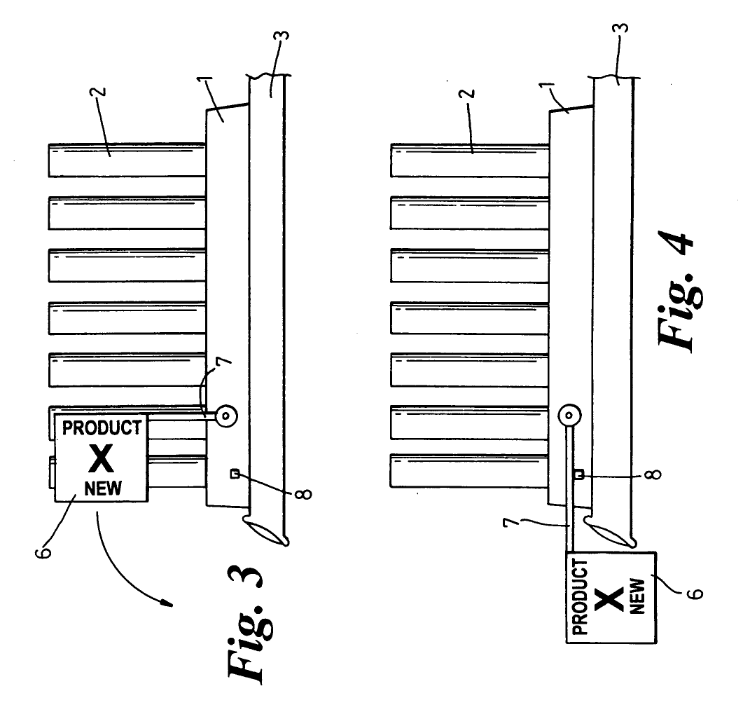

Turning now to FIGS. 2 to 5, there is shown an alternative system in accordance with the invention in which the merchandising tray 1 includes signage in the form of a sign or flag 6 secured to one end of a swivellably mounted flag staff 7 and associated stop member 8. In the position shown in FIGS. 2 and 4, the flag 6 is shown in its extended position where it can promote sale of the products 2, and as shown in FIG. 3 the flag 6 may also be selectively stored away when not in use or when not required, so that it is substantially hidden by the products 2 and adjacent products from adjacent trays 1.

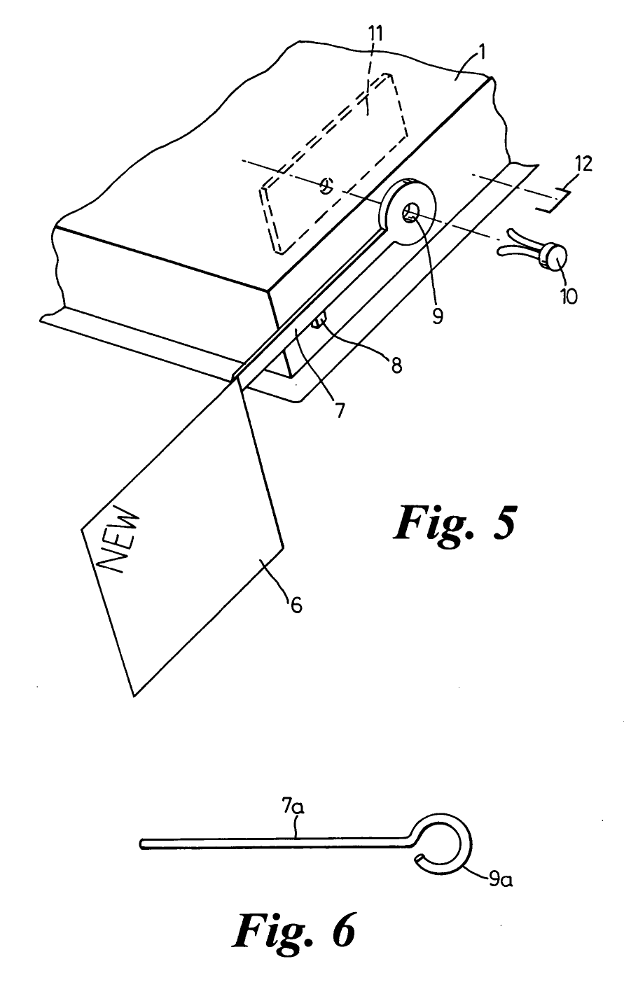

As shown in FIG. 5, the flagstaff 7 includes an eyelet portion 9 at its end remote from the flag 6, through which is insertable a deformable headed fastener 10 which also extends through a corresponding aperture in the side wall of the merchandising tray 1 and through an anchor plate 11 on the opposite side thereof, which plate 11 is secured to the side wall of the merchandising tray 1 by means of a staple 12.

In the embodiment shown in FIG. 6, the flagstaff 7a takes the form of a bent wire rod having at one end thereof an eyelet 9a for swivellably securing the flagstaff 7a to a sidewall of the merchandising tray 1 (not shown). A flag or sign (not shown) can thereafter be secured to the flagstaff 7a at the point of sale, if so required.

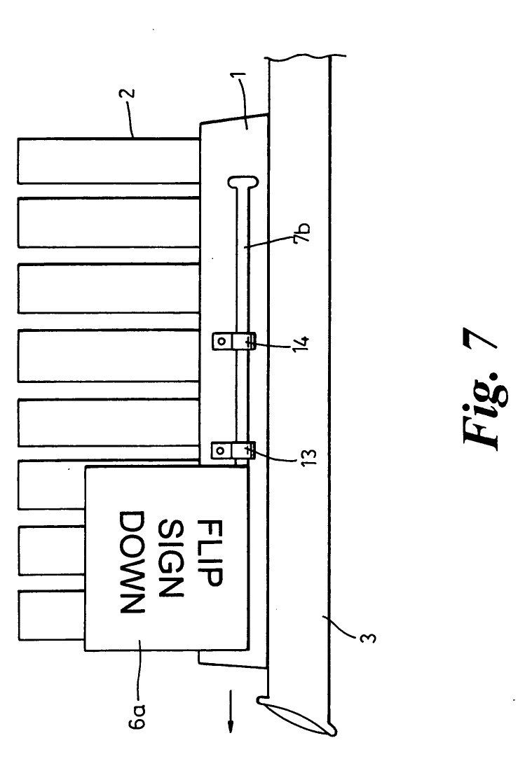

Turning now to FIG. 7, there is shown an alternative arrangement in which the signage takes the form of a sign or flag 6a mounted on a slidable flagstaff 7b retained by a pair of collars 13, 14 permitting the sign or flag 6a to be slid outwardly in the direction arrowed and then flipped through 90° to overhang the front of the shelf 3.

As will be apparent, with this embodiment of the invention the sign or flag 6a can be stored in a particularly compact fashion relative to the products 2 since the flagstaff 7b is not swivelled about an axis but is instead simply slidable outwardly for use, if required.

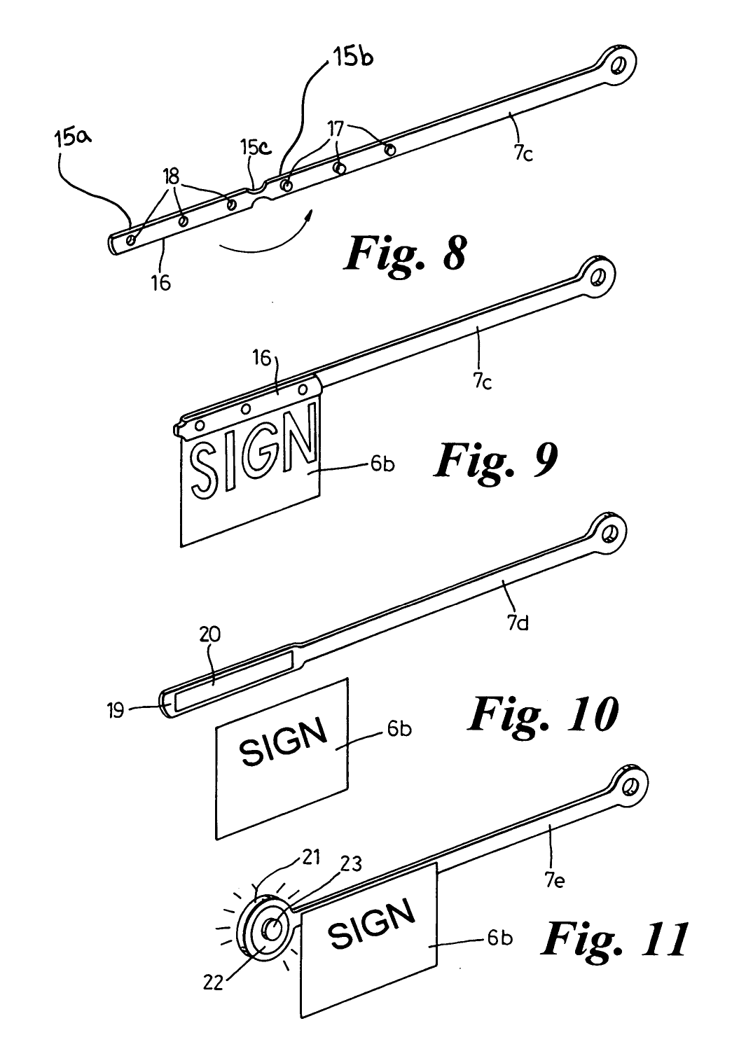

Referring now to FIGS. 8 and 9, there is shown an alternative embodiment of flagstaff 7c having a living hinge at free end 16. The living hinge includes first portion 15a, second portion 15b and waist region 15c. The first and second portions 15a, 15b have cooperating locking elements 18, 17, respectively. Waist region 15c acts as a ‘living hinge’ by which the free end 16 of the flagstaff 7c can swivel in the direction arrow, such that the living hinge folds at said waist region 15c and first portion 15a overlaps second portion 15b. The locking elements 18 of first portion 15a cooperate with the locking elements 17 of second portion 15b to secure first portion 15a to second portion 15b as shown in FIG. 9. Sign 6b can be secured to flagstaff 7c by the living hinge by positioning sign 6b between first portion 15a and second portion 15b and interlocking locking elements 17, 18 through sign 6b. Locking elements 17, 18 may be in the form of locking pips or formations 17 and associated sockets 18, which allow the pips 17 to be pushed fitted therewithin, to thereby retain a flag or sign 6b on flagstaff 7c.

In FIG. 10 there is as alternative arrangement in which the flag or sign 6b can be retained on the end of the flagstaff 7d by means of the latter having at its free end a flattened region 19 onto which is adhesively secured a strip of double sided tape 20 which can therefore be selectively used to attach a flag or sign 6b as required.

In the embodiment shown in FIG. 11 visual enhancement means is shown which takes the form of an annular socket 21 at the free end of the flagstaff 7e and into which can be snap fitted a battery operated visual display enhancement device 22 with a centrally disposed LED 23 which can e.g. be made to flash repeatedly in order to draw attention to the flag or sign 6b. Alternatively, the visual display enhancement device 22 may be insertable within a socket within some other part of the merchandising tray 1 so as to draw attention to it if desired.

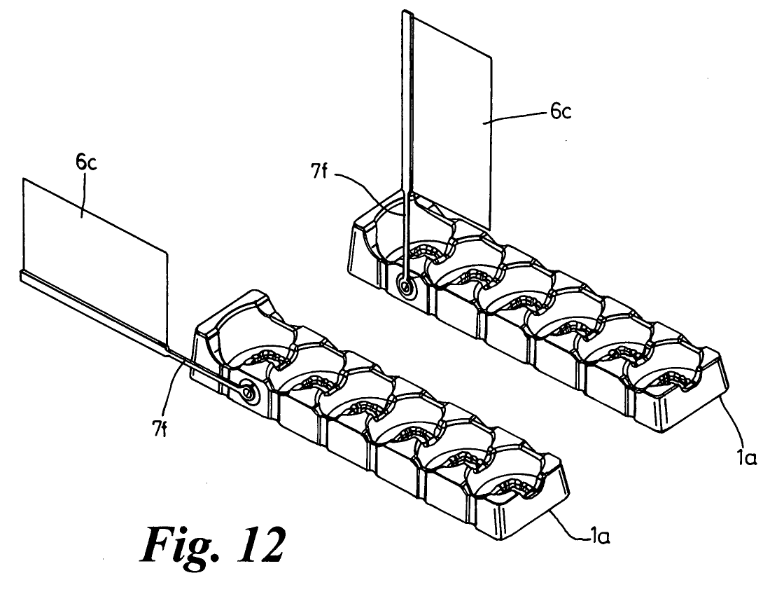

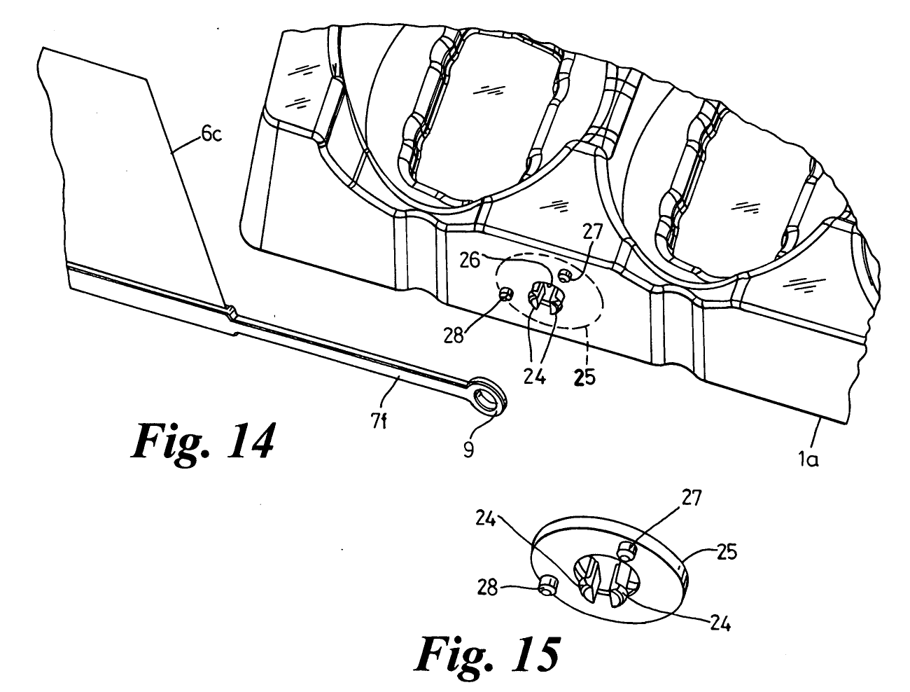

Turning now to the embodiment shown with reference to FIGS. 12 to 15, there is shown a merchandising tray 1a having a flagstaff 7f and associated signage 6c pivotable from an upright position adjacent to product (not shown) stored on the tray 1a to an exposed horizontal position extending therefrom. As is shown more clearly with reference to FIGS. 14 and 15, the end of the flagstaff 7f remote from the flag or sign 6c is provided with an eyelet 9 by which the flagstaff 7f can be push-fitted onto a flanged pair of spigot halves 24 extending from and forming part of a flagstaff mounting bracket 25 (shown partly in outline in FIG. 14) insertable within an aperture 26 in a sidewall of the housing 1a.

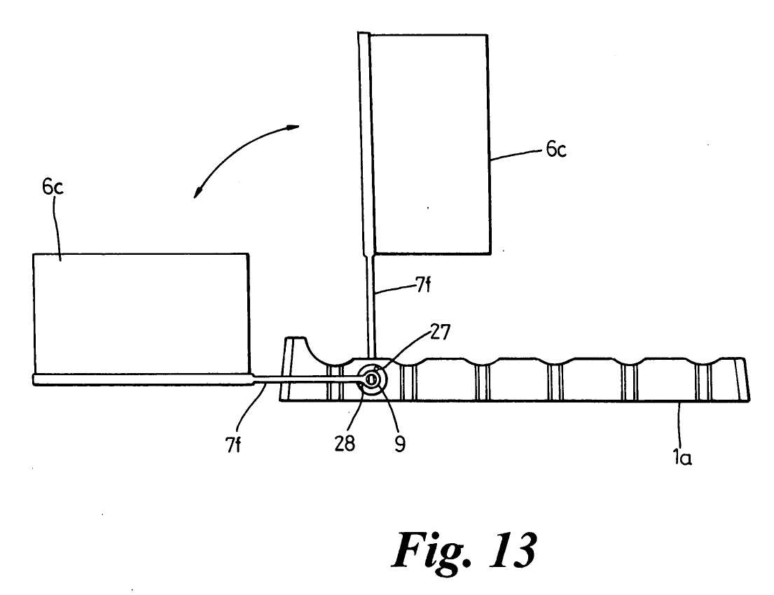

Extending from the mounting bracket 25 are a pair of stop members 27, 28 set at 90° to each other relative to the central axis of the spigot halves 24, the stop members 27, 28 extend through apertures (not shown) in sidewall portions of the merchandising tray 1a such that when the flagstaff 7f is mounted on the spigot halves 24 movement is limited to the positions shown arrowed in FIG. 13, the upright position being adjacent to and hence hidden by products (not shown) being carried by the merchandising tray 1a, to a position in which the flagstaff and flag or signage 6c is moved to a horizontal position in which the flagstaff adjacent the eyelet 9 bears against the stop member 28.

As will be apparent, in the embodiment shown with reference to FIGS. 12 to 15, the mounting bracket 25, associated flagstaff 7f and associated signage 6c can be either assembled onto the merchandising tray 1a during packing thereof, or they may be provided separately so that the merchandising tray 1a can selectively be provided with such signage or not, as the case may be. The provision of holes in the sidewall of the merchandising tray 1a through which the stop members 27, 28 extend also cooperate therewith to ensure that the bracket member 25 does not rotate within the aperture 26, thereby providing respective upright and horizontal configurations for the flagstaff 7f as required.

The invention in its various forms therefore provides a simple and inexpensive way of selectively promoting the sale of products on their associated merchandising tray without the need for separate signage being made available within the store in which the merchandising tray is located.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A merchandising tray for holding and displaying products, the merchandising tray comprising:
a portion for carrying the products; and
movable signage, the movable signage movable between a stored position in which the signage is substantially hidden from view by a customer viewing the products by at least a part of the products displayed in the tray and an exposed position in which the signage is readily visible to the customer viewing the products.

2. A merchandising tray according to claim 1 wherein the signage comprises a flag and an associated flagstaff.

3. A merchandising tray according to claim 2 wherein the flagstaff is swivellably connected to a part of the merchandising tray such that said flagstaff is swivellable from said stored position to said exposed position.

4. A merchandising tray according to claim 2 wherein said flagstaff is slidably mounted on the merchandising tray such that said flagstaff is slidable between said stored position and said exposed position.

5. A merchandising tray according to claim 2 wherein the flagstaff includes a first end movably engaged with the tray, an opposite free end, and a living hinge near said free end; said living hinge having a first portion, a second portion and a waist region therebetween, said first and second portions having cooperating locking elements, said living hinge foldable at said waist region such that said first portion overlaps said second portion and said locking elements of said first portion cooperate with said locking elements of said second portion to secure said flag to said flagstaff.

6. A merchandising tray according to claim 5 wherein said locking elements comprise interlocking formations.

7. A merchandising tray according to claim 2 wherein the flagstaff includes a first end movably engaged with the tray and an opposite free end, the free end of the flagstaff is flattened and includes a strip of adhesive and a removable cover associated over said adhesive, said cover removable to allow attachment of said flag to said adhesive.

8. A merchandising tray according to claim 2 further comprising a visual enhancement socket, said socket receiving a visual enhancement device.

9. A merchandising tray according to claim 8 wherein said visual enhancement socket is disposed on said signage.

10. A merchandising tray according to claim 9 wherein said visual enhancement device is a battery operated LED.

11. A merchandising tray according to claim 3 wherein said part of the tray includes at least one stop member, said stop member limiting the swivel movement of said flagstaff.

12. A merchandising unit for displaying products to a customer, said merchandising unit comprising:
a merchandise tray for holding the products; and
a sign assembly movably engaged with said tray and including a flag, said sign assembly movable between an exposed position wherein the said flag is visible to the customer and a stored position wherein said flag is substantially hidden from view by the customer.

13. A merchandising unit according to claim 12 wherein the sign assembly includes a flagstaff, said flagstaff movably attached to said tray at one end and having an opposite free end, said flag attached to said free end of said flagstaff.

14. A merchandising unit according to claim 13 wherein the flagstaff is swivellably connected to said tray such that said flagstaff swivels from said stored position to said exposed position.

15. A merchandising unit according to claim 13 wherein said flagstaff is slidably mounted on said tray such that said flagstaff is slidable between said stored position and said exposed position.

16. A merchandising unit according to claim 13 wherein said free end of said flagstaff includes a living hinge; said living hinge having a first portion, a second portion and a waist region between said first and second portions, said first and second portions having cooperating locking elements, said living hinge foldable at said waist region such that said first portion overlaps said second portion and said locking elements of said first portion cooperate with said locking elements of said second portion to secure said flag between said first and second overlapping portions.

17. A merchandising unit according to claim 13 wherein said free end of the flagstaff includes a strip of adhesive and a removable cover is disposed over said adhesive, said cover removable to allow attachment of said flag to said flagstaff.

18. A merchandising unit according to claim 13 further comprising a visual enhancement socket, said socket receiving a visual enhancement device.

19. A merchandising unit according to claim 18 wherein said visual enhancement socket is disposed on said flagstaff.

20. A merchandising unit for displaying products to a customer, said merchandising unit comprising:
a merchandise tray for holding the products; and
a sign assembly including a flagstaff and a flag, said flagstaff having a first end movably attached to said tray and an opposite free end, said flag attached to said free end of said flagstaff, said flag staff movable between an exposed position wherein the said flag is visible to the customer and a stored position wherein said flag is substantially hidden from view by the customer.

21. A merchandising unit according to claim 20 wherein said first end of said flagstaff is pivotably attached to said tray.

22. A merchandising unit according to claim 20 wherein said first end of said flagstaff is slidably attached to said tray.
